(19) United States
(12) Patent Application Publication
(10) Pub. No.: US 2012/0047697 A1
(43) Pub. Date: Mar. 1, 2012

(54) CARD HOLDER AND SIMILAR ELEMENTS

(76) Inventors: Jose Daniel Vargas Cervantes, Guanajuato (MX); Mabel Guadalupe Diaz Lopez, Guanajuato (MX); Eduardo Diaz Lopez, Guanajuato (MX)

(21) Appl. No.: 13/256,835

(22) PCT Filed: Mar. 10, 2009
(86) PCT No.: PCT/MX09/00021

§ 371 Date: Nov. 8, 2011

(51) Int. Cl. B42F 1/10; F16B 2/20

(52) U.S. Cl. 24/489; 24/455

(57) ABSTRACT

It provides a fastener to hold small cards and paper sheets, includes a base of cardboard, plastic or some other material with condition that provides the desired portability. It also provides a method for inserting paper sheets and cards to the clip.

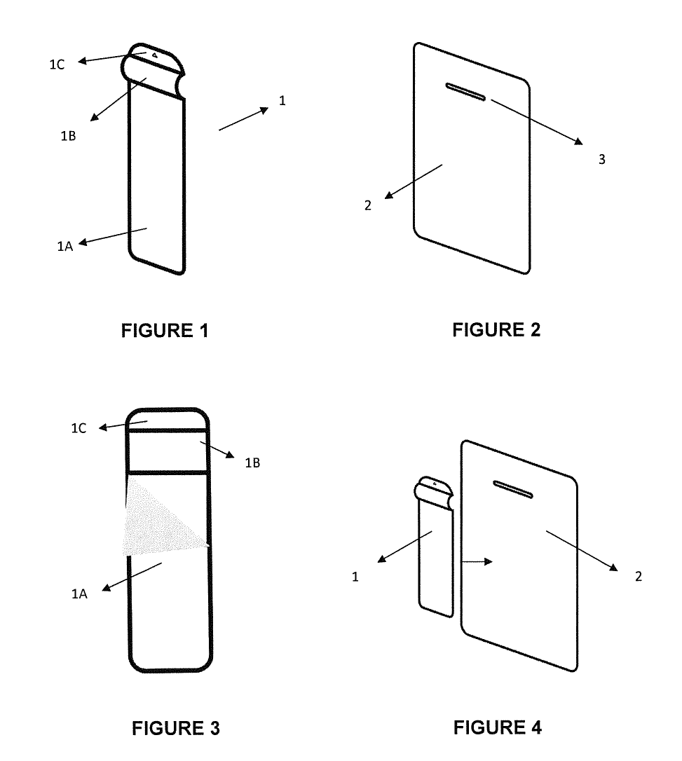

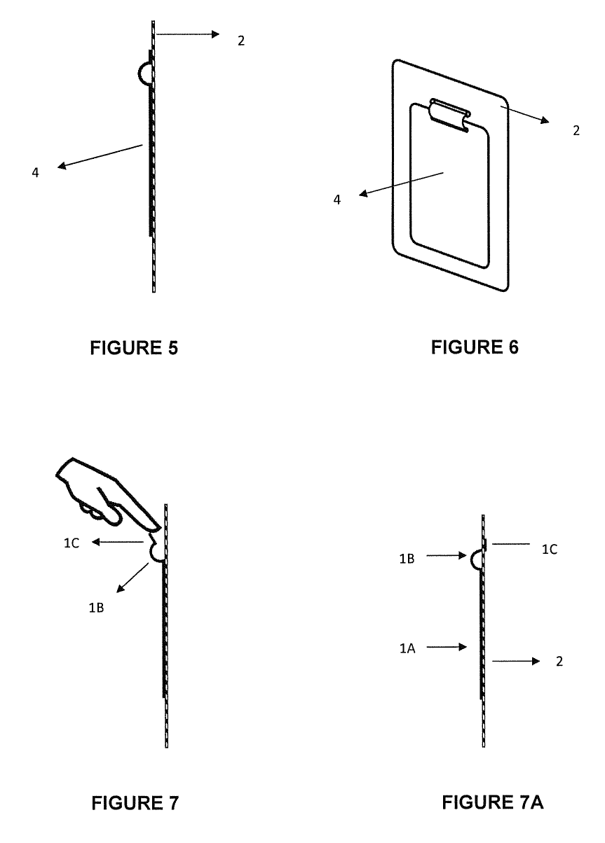

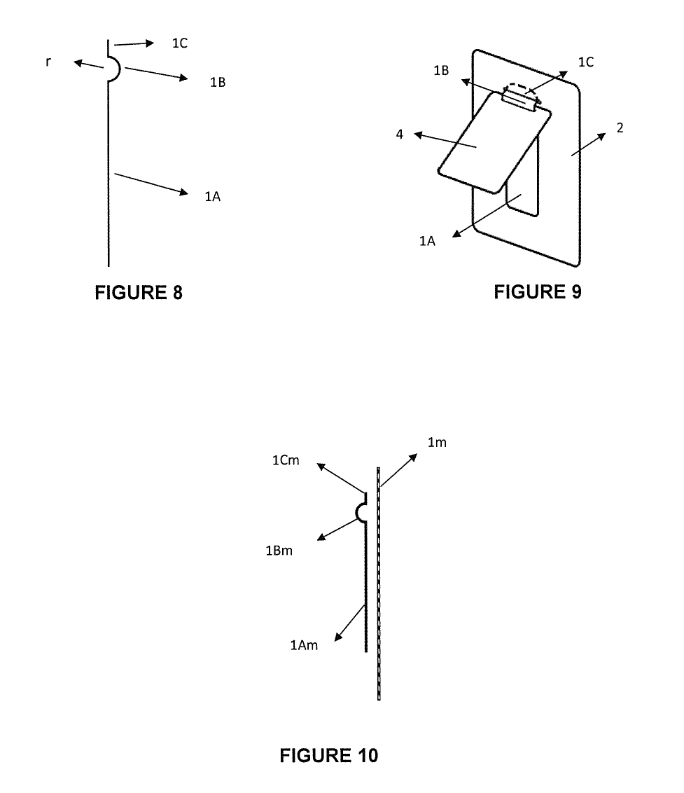

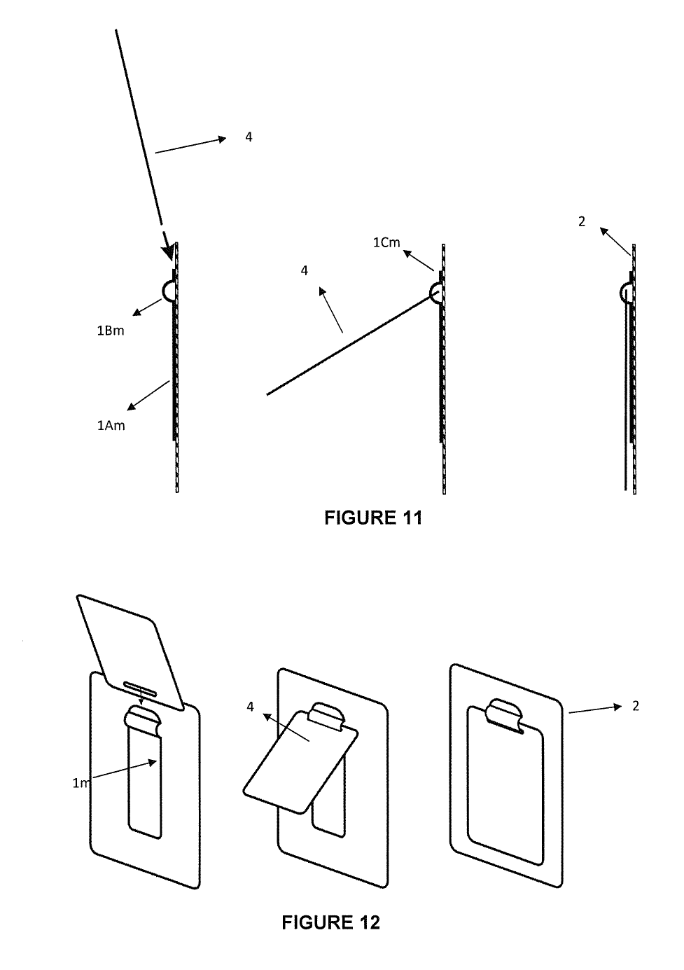

### INVENTION BACKGROUND AND FIELD

The following invention refers to a card and paper sheets clip, and small similar elements.

There are bases, holders, sheets holders, etc, that their main function is to hold a given number of sheets or cards.

We have as an example, the document WO2008/072384, it refers to a card clip and a calendar made of paper (10) in general it refers to a calendar with a paper card clip. It is an article elaborated with two connected pieces movable by a series of adjacent properties (8) to a plastic binding, and they look like they hang of an element such as a nail or screw on the wall.

Another invention is related to the patent ES 2 108 573, which refers to a letters holder that utilizes a round clip to hold letters, the invention provides an appearance of improper use. The letters can only be changed through the round clip separation (30) attached to a base (12).

The Mexican patent MX 201884 refers to a card display for tools. The display card has some slots to form tabs and cards, and finally the patent U.S. Pat. No. 2,386,840, which describes a note pad with a writing element (6).

None of the previous documents describes a system so simple and efficient as the one is described here, which incorporates, essentially, a strip of elastic or flexible material, a base to hold the strip, with a slot in that base and a double face adhesive or a similar element to fasten it.

### BRIEF DESCRIPTION OF THE IMAGES

Image 1 is a top perspective view that shows the strip of plastic material.

Image 2 is a perspective view of the base.

Image 3 is a rear view of the plastic material strip showing the adhesive site.

Image 4 is a view showing the plastic strip and the base before they are merged throughout the adhesive.

Image 5 is a side view of the whole assembly without cards and without introducing the tab on the plastic strip into the slot of its base.

Image 6 shows the holder with a card inserted and fastened.

Images 7 and 7A, are a side views showing the strip in receiving position of the cards and in closed position and storage, respectively.

Image 8 is a right side view of the plastic strip.

Image 9 is an isometric view from the whole assembly base set, clip, plastic strip and card.

Image 10 shows a right side view of a form of the invention which uses a metal strip instead of a plastic one.

Image 11 shows a right side view of the steps to insert a card in the metal strip mode.

Image 12 shows a top right isometric view of the steps to insert a card in the metal strip mod

### DETAILED DESCRIPTION OF THE INVENTION

The current invention relates to a fastener to hold cards, loose sheets, and similar items that include visual information.

The fastener includes a strip of plastic material 1 which includes three zones 1A, 1B and 1C; the first one 1A, is a straight, flat part which binds an element of double sided adhesive on the side back, the second zone 1B, in semi cylindrical form, and finally the third area 1C of assurance which is straight and smaller in size than any of the above areas. In addition to the previous strip, the fastener comprises a base 2 generally made out of cardboard, plastic or similar material and their combinations, as long as it complies with the feature of portability. This base includes a horizontal groove 3 of sufficient size to enable the inclusion of the third zone 1C of the plastic strip 1 to allow the admission of the cards 4 to the second area 1B of the strip and/or to prevent the exit of these from the second area. Obviously the cards, sheets or materials placed, must have a corresponding slot with the horizontal groove 3 for its introduction into the strip of plastic material.

Finally, the fastener is complemented by a two-sided adhesive, which links the strip of plastic material with the base. This adhesive can be exchanged by any other means of adequate union between the plastic strip and the base.

The fastener is therefore composed by a base and a plastic material strip of special configuration. It functions in the following manner; once the parts are assembled as shown in any of the images from 5 to 8, the fastener is ready to receive the material that is intended to group or display.

From image 5, is shown that the part 1C is removed with a finger and with it part 1B, and the part 1A is fixed to the base. Thus, the fastener can admit the cards 4 until saturate the space between zone 1B and the base 2, once the desired cards have been inserted, we proceed to insert the zone 1C in the slot 3 to ensure that the cards are in position. It is important to point out that the part 1C can be removed with the same card that is inserted or with two fingers, holding the edges of the part 1B.

Image 8 shows the part 1B with a radius r 0.5 cm±40%. The plastic strip 1 should be constructed with poly paper caliber 12, the length of the area 1A is not relevant, while the length of the zone 1C must be such that it allows its introduction in the opening 3 of the base 2. It is an indispensable requirement that the radius r is 0.5 cm±40%. The width of the strip 1 can vary from 0.5 cm to 3.0 cm for the very best results. It has been specifically selected the 12 caliber in this type of material, the radius r 0.5 cm and the variable width of the plastic strip is in the range mentioned above, since the mechanical properties that this combination provides are the best to obtain the optimum result in terms of quantity of elements to fasten and ease of construction and manoeuvrability of the plastic strip.

In the image 9, the card is in its ascending journey in order to remain completely open. The space formed by part 1B with the base allows the introduction of a writing element such as a pencil or a pen with the proper dimensions. This is an additional advantage from the present invention to provide a way with the necessary elements, to make notes.

The invention also relates to a method to hold cards or sheets of paper of small dimensions with the purpose to display varied information such as advertising or information of particular or general interest. Also blank sheets can be placed to write on them, and in the same fastener can be placed a writing element such as a pencil.

The method includes, using the fastener described above, to separate the third zone 1C and the second zone 1B and insert the sheets of paper or cards, once that the amount of cards or sheets has been placed, ensure the third zone of the plastic strip with the base, inserting it in the horizontal slot 3 in the base, with which the paper sheets or cards can be manipulated without risk of falling or leaving out of the plastic strip.

In a mode of the invention, the plastic strip is not plastic anymore and becomes a metal strip, images 9 to 12. This change in material while it may be obvious to an expert in this field, it is not, because it implies a change in the main characteristic in which the method is based to insert the cards or paper sheets. This feature is the capability to resume its shape and position of the plastic material, which we do not find in average metal and under conditions for which has been designed the present invention.

Therefore, a present invention mode includes the use of a strip of metal material lm such as stainless steel, carbon steel alloy or non-alloy steel, aluminum, bronze, copper etc. In order to exemplify and not to limit the scope of the invention, the present mode of the invention particularizes using stainless steel or aluminum.

Being a much more rigid material, the metal strip will require a different thickness and a form of work slightly different. For example if the metal strip is constructed in stainless steel, will have a caliber of 0.0025 cm to 0.508 cm. In the case of the aluminum, and the same of stainless steel, different thicknesses can be chosen depending of the specific alloy, it can vary from 0.0051 cm to 0.0787 cm.

As a result of the stated before, the base of using this mode lacks of the slot 3. The necessary force to maintain the sheets of paper in position it is provided by the mechanical resistance of the metal. This implies that the part 1Cm is exposed all the time to the front of the base 2. The parts 1B and 1A correspond to the parts 1Bm and 1Am on this metallic mode.

The metallic element 1m is attached permanently to the base by means of an adhesive or some other fixation element.

Having described sufficiently the invention, it is considered to be as novelty, with inventive activity and industrial application, therefore it is claimed as property expressed and contained in the following clauses claiming ownership:

1. A clip, for cards and similar elements is characterized because it includes a base with a horizontal slot and a plastic strip, where the plastic strip comprises an adhesive to attach it to the base.

2. The clip, in accordance to the claim 1, is characterized because the plastic strip includes a first zone, a second zone and a third zone, where the second zone is a radio that covers the width of the plastic strip.

3. The clip, in accordance to the claim 2, is characterized because the plastic strip is of poly-paper caliber 12, and the radio of the second zone is 0.5 cm±40%, in this radio can be inserted one element of writing as a pen or pencil.

4. The clip, in accordance to the claim 3, is characterized because the third zone of the plastic strip has the dimensions and precise placement to be inserted in the horizontal slot from the base to hold the cards, once such cards have been introduced in the second zone.

5. The clip, in accordance to the claim 4, is characterized because the first zone is attached permanently to the base by means of an adhesive double-sided or a similar item.

6. The clip, in accordance to the claim 5, is characterized because the base is built of the group of elements made by cardboard, plastic or similar material, and their combinations.

7. A clip, for cards and similar elements, is characterized because comprises a base and a metallic strip, where the metallic strip joins fixed to the base.

8. The clip, in accordance to claim 7, is characterized because the metallic strip comprises a first zone, a second zone and a third zone, where in the second zone there is a radius that covers the width of the metallic strip.

9. The clip in accordance to claim 8, is characterized because the plastic strip is stainless steel with a thickness of 0.0025 cm to 0.508 cm and the radius of the second zone is of 0.5 cm±40%, in this radius can be placed one element of writing such as a pen or pencil.

10. The clip according to claim 8, is characterized because the plastic strip is aluminum with a thickness of 0.0051 cm to 0.0787 cm and the radius of the second zone is of 0.5 cm±40%, in this radius can be placed one element of writing such as a pen or pencil.

11. The clip, according to claim 9 or 10, is characterized because the base is built of the group of elements, made out of cardboard, plastic or similar material.

12. A method to hold cards and paper sheets, the method is: using the clip of the claim 1, separating the third zone and the second zone and to introduce the paper sheets or cards. Once that has been placed the number of cards desired, ensure the third zone to the base by inserting into the horizontal slot of the base so that the paper sheets or the cards can be manipulated without risk of falling or leaving the plastic strip.
